(19) United States
(12) Patent Application Publication
(10) Pub. No.: US 2013/0011244 A1
(43) Pub. Date: Jan. 10, 2013

(54) RECONFIGURABLE HEAT TRANSFER SYSTEM FOR GAS TURBINE INLET

(75) Inventors: Yongjiang Hao, Shanghai (CN); Barry Lester Agee, Greer, SC (US); Bradly Aaron Kippel, Greer, SC (US); Tiecheng Wang, Shanghai (CN)

(73) Assignee: GENERAL ELECTRIC COMPANY, Schenectady, NY (US)

(21) Appl. No.: 13/634,547

(22) PCT Filed: Jul. 29, 2010
(86) PCT No.: PCT/CN2010/001147

§ 371 Date: Sep. 12, 2012

(51) Int. Cl. F01D 25/14; F16K 49/00; F01D 1/04

(52) U.S. Cl. 415/145; 137/334

(57) ABSTRACT

A reconfigurable heat transfer system for a turbine inlet for a gas turbine engine is disclosed. The reconfigurable heat transfer system includes reconfigurable heat transfer components may be moved between a first position and a second position, wherein the second position allows a portion of or all of the air in the inlet to bypass the heat transfer components.

### BACKGROUND OF THE INVENTION

The subject matter disclosed herein relates to gas turbine engines, and more specifically, to air conditioning systems used in turbine inlets.

In general, gas turbine engines combust a mixture of compressed air and fuel to produce hot combustion gases. The combustion gases may flow through one or more turbine stages to generate power for a load and/or a compressor. Upstream of the gas turbine engine, an air conditioning system may cool the intake air for power augmentation or heat the air for anti-icing. Unfortunately, the air conditioning system causes a significant pressure drop in the intake air thereby causing a decrease in the power output by the gas turbine. This pressure drop, and resulting power decrease, is particularly detrimental during non-operational periods of the air conditioning system.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a turbine air intake comprising one or more reconfigurable heat transfer components configured to exchange heat with an airflow. Each reconfigurable heat transfer component is reconfigurable between a first position and a second position, and a second position opens a bypass region for the airflow.

In a second embodiment, a turbine air intake includes a reconfigurable heat exchanger. The reconfigurable heat exchanger includes a first configuration and a second configuration, wherein the second configuration opens a bypass for airflow.

In a third embodiment, a system includes a compressor of a gas turbine engine and a turbine air intake coupled to the compressor and configured to provide air to the compressor. The turbine air intake includes one or more stationary coil panels and one or more reconfigurable coil panels, and each reconfigurable coil panel is reconfigurable between a first position and a second position, wherein the second position opens a bypass region for the airflow

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic flow diagram of an embodiment of a gas turbine engine in accordance with an embodiment of the present invention;

FIGS. 2A and 2B are cross-sectional side views of a turbine inlet depicting a first position and second position of translatable heat transfer components in a turbine inlet in accordance with an embodiment of the present invention;

FIGS. 3A and 3B are cross-sectional top views of a turbine inlet depicting a first position and second position of translatable heat transfer components in accordance with an embodiment of the present invention;

FIGS. 4A and 4B depict a connection system for the translatable heat transfer components of FIGS. 2 and 3 in accordance with an embodiment of the present invention;

FIGS. 5A and 5B depict cross-sectional side views of a turbine inlet depicting a first position and second position of translatable heat transfer components in accordance with another embodiment of the present invention;

FIGS. 6A and 6B depict a connection system for the translatable heat transfer components of FIG. 5 in accordance with an embodiment of the present invention.

FIGS. 7A and 7B depict front and top views respectively of a ball screw mechanism for moving translatable heat transfer components in accordance with an embodiment of the present invention;

FIGS. 8A and 8B depict cross-sectional side views a turbine inlet depicting a first position and second position of translatable heat transfer components in accordance with an embodiment of the present invention

FIGS. 9A and 9B depict front and top views respectively of a ball screw mechanism for moving the translatable heat transfer components of FIG. 8 in accordance with an embodiment of the present invention;

FIGS. 10A and 10B are cross-sectional top views of a turbine inlet depicting a first position and second position of rotatable heat transfer components in accordance with another embodiment of the present invention;

FIG. 11 depicts a cross-sectional front view of a turbine inlet and the rotatable heat transfer components of FIG. 10 in accordance with an embodiment of the present invention;

FIG. 12 depicts a cross-sectional side view of a turbine inlet and the rotatable heat transfer components of FIG. 10 in accordance with an embodiment of the present invention;

FIGS. 13A and 13B are cross-sectional top views of a turbine inlet depicting a first position and second position of rotatable heat transfer components in accordance with an embodiment of the present invention;

FIGS. 14A and 14B are cross-sectional top views of the a turbine inlet depicting a first position and second position of rotatable heat transfer components in accordance with another embodiment of the present invention;

FIGS. 15A and 15B are cross-sectional side views of a turbine inlet depicting removable heat transfer components in accordance with an embodiment of the present invention; and

FIGS. 16A and 16B are cross-sectional side views of a turbine inlet depicting removable heat transfer components in accordance with an embodiment of the present invention.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

Embodiments of the present invention include a turbine inlet (e.g., air intake for gas turbine engine) having reconfigurable heat transfer components of an air conditioning system. Heat transfer components disposed in the inlet may be reconfigured to maximize heat transfer with the inlet air or to allow inlet air to bypass some or all of the heat transfer components, thus minimizing or eliminating any pressure drop introduced by the heat transfer components. For example, the pressure drop may be eliminated or reduced during non-operational periods of heat transfer components. Embodiments may include translatable heat transfer components that may be translated between a first position and a second position, rotatable heat transfer components that may be rotated between a first position and a second position, and removable heat transfer components that may be removed from the inlet.

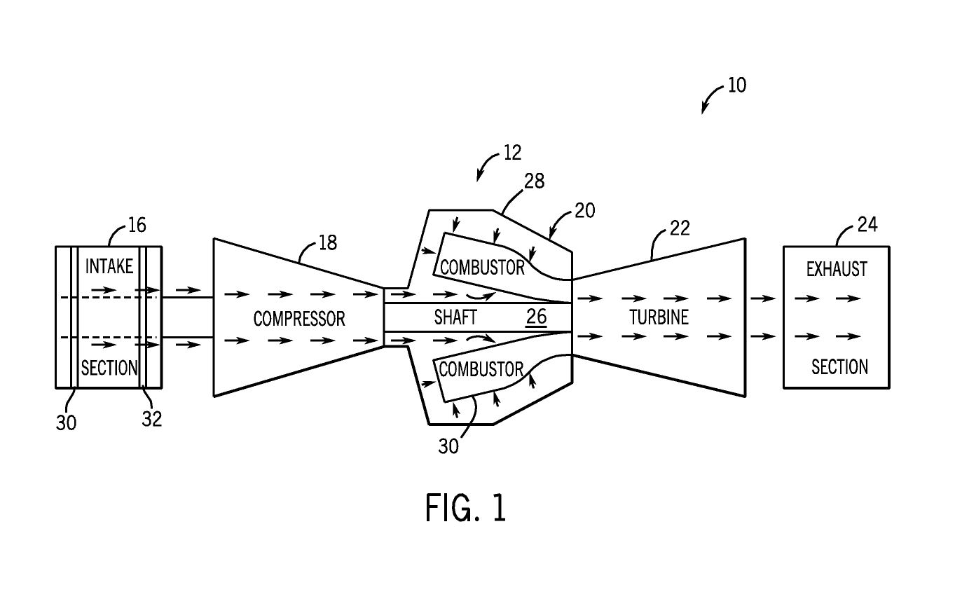

FIG. 1 is a block diagram of an exemplary system 10 including a gas turbine engine 12 that may include the reconfigurable heat transfer system disclosed herein. In certain embodiments, the system 10 may include an aircraft, a watercraft, a locomotive, a power generation system, or combinations thereof. The illustrated gas turbine engine 12 includes an inlet 16, a compressor 18, a combustor section 20, a turbine 22, and an exhaust section 24. The turbine 22 is coupled to the compressor 18 via a shaft 26.

As indicated by the arrows, air may enter the gas turbine engine 12 through the inlet 16 and flow into the compressor 18, which compresses the air prior to entry into the combustor section 20. The illustrated combustor section 20 includes a combustor housing 28 disposed concentrically or annularly about the shaft 26 between the compressor 18 and the turbine 22. The compressed air from the compressor 18 enters combustors 29 where the compressed air may mix and combust with fuel within the combustors 29 to drive the turbine 22.

From the combustor section 20, the hot combustion gases flow through the turbine 22, driving the compressor 18 via the shaft 26. For example, the combustion gases may apply motive forces to turbine rotor blades within the turbine 22 to rotate the shaft 26. After flowing through the turbine 22, the hot combustion gases may exit the gas turbine engine 12 through the exhaust section 24.

The turbine inlet 16 may include one or more filters 30 and one or more heat transfer components 32. In some embodiments, the one or more filters 30 may be positioned upstream, downstream, or both from the heat transfer components 32. The filter 30 may be any suitable filter configured to remove particles and/or other material from the incoming air received by the inlet 16. The one or more heat transfer components 32 (also referred to as an “air conditioning system”) may be one or more coil panels, evaporative cooler media, or other suitable heat transfer components.

As discussed further below, heat transfer components such as coils in a coil panel may be coupled to a source of fluid to transfer heat away from or to the heat transfer components. As air enters the inlet 16, the air passes through the filter 30 and over the heat transfer components 32 to exchange heat with the heat transfer components 32. Thus, before entering the compressor 18, the air may be cooled below ambient temperature to increase the efficiency of the turbine. In other embodiments, the heat transfer components 32 may be used to transfer heat to the air, such as by providing heated fluid in coils of a coil panel. In such an embodiment, the heat transfer components 32 may increase the temperature of the air to above ambient temperature before the air enters the compressor 18.

The heat transfer components 32 may add a pressure drop to the inlet air as the inlet air passes over the heat transfer components 32. For example, the heat transfer components may introduce a pressure drop of about 0.5 inches to about 1.5 inches of water column. This pressure drop may result in a corresponding decrease in output of the gas turbine engine 12. For example, for a pressure drop of about 0.5 inches to about 1.5 inches of water column, the gas turbine output may decrease from about 1 to about 5 MW, resulting in a decrease of efficiency of about 0.01% to about 0.3%.

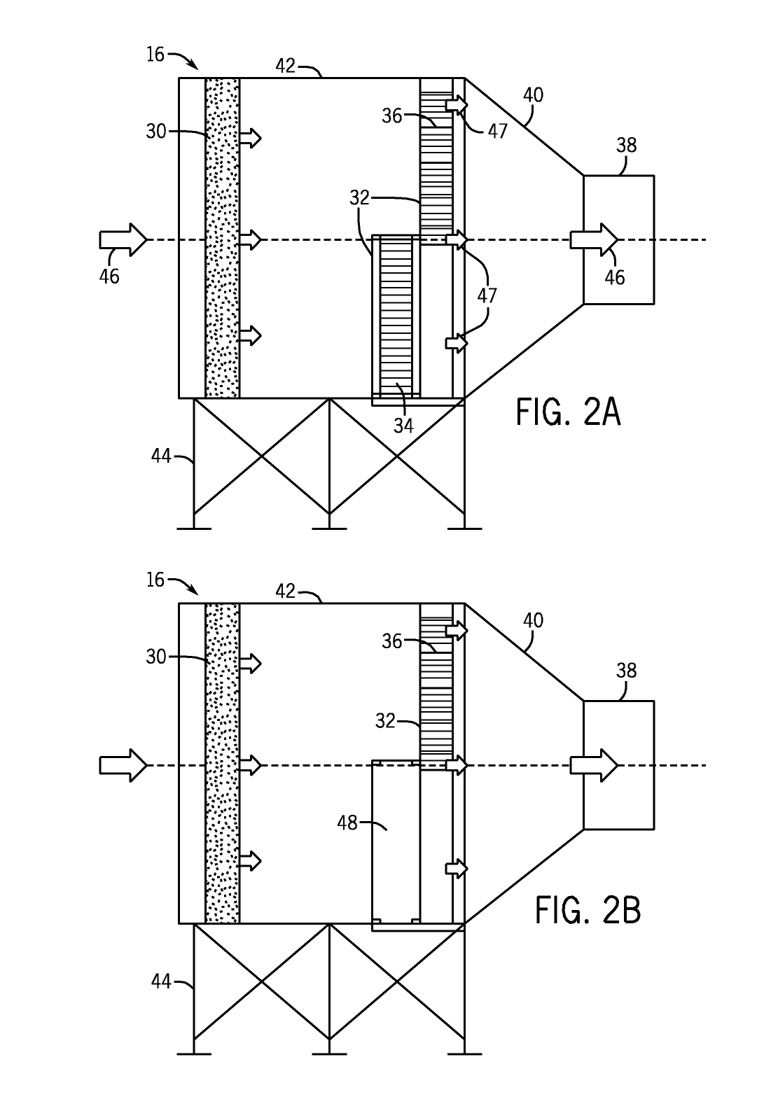

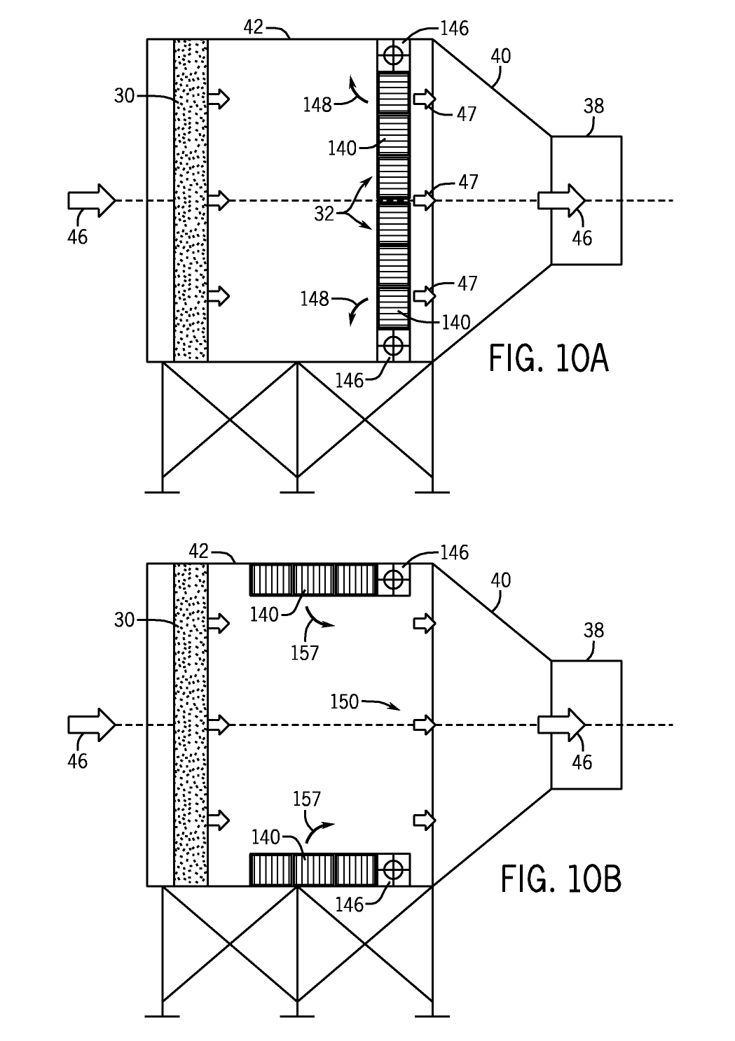

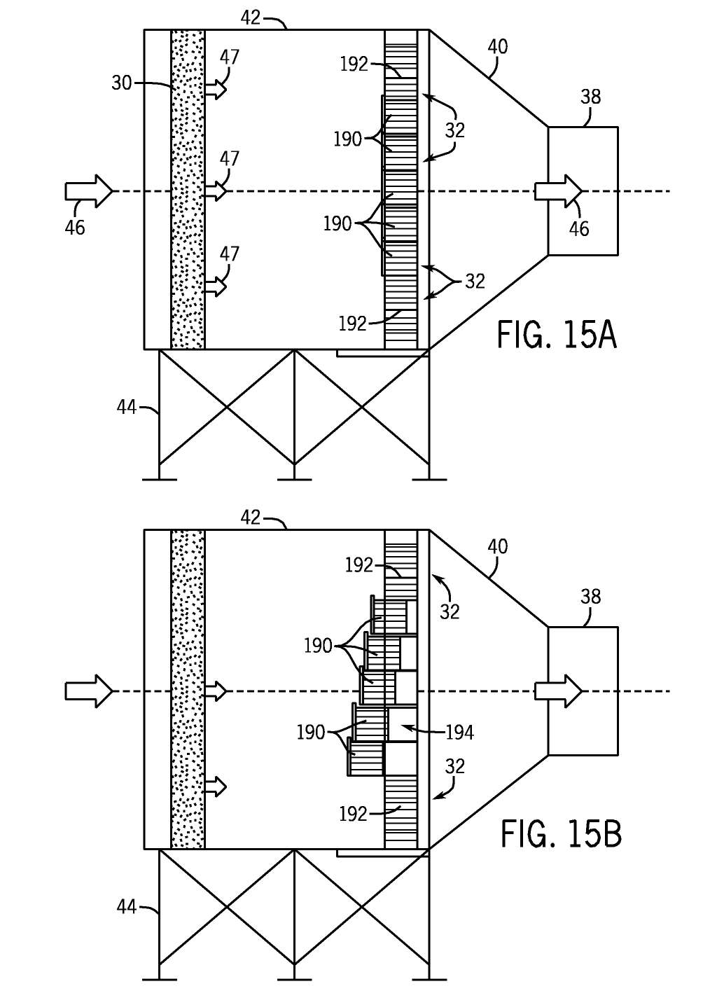

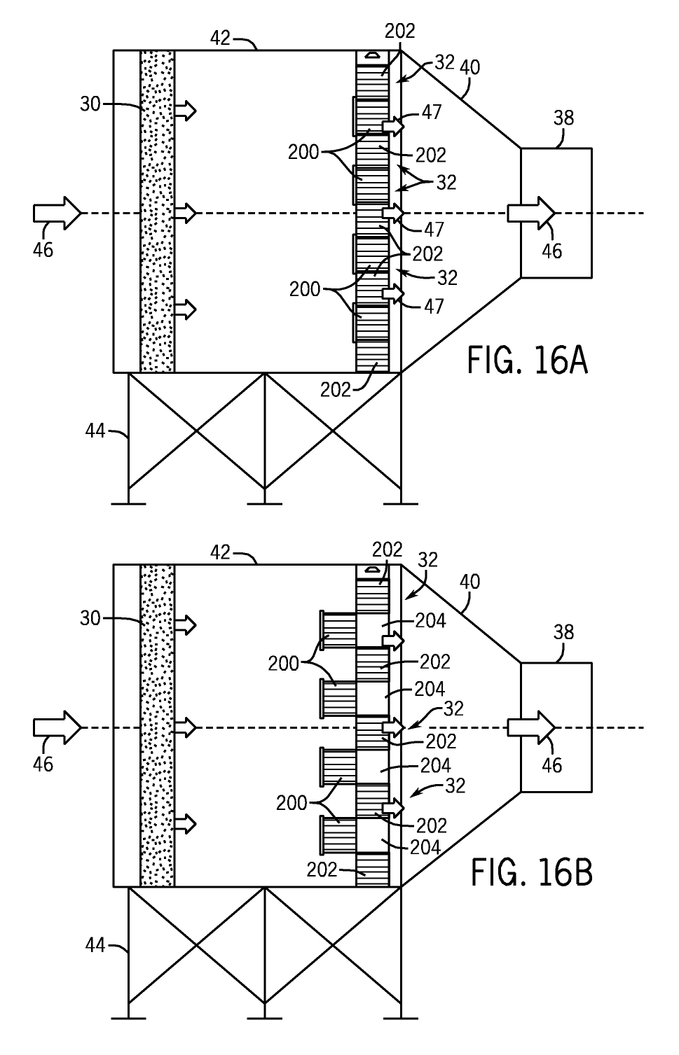

FIGS. 2-16 depict various embodiments of the turbine inlet 16 having reconfigurable heat transfer components 32. In each embodiment, the heat transfer components 32 may be reconfigured to maximize heat transfer with the inlet air or to allow inlet air to bypass some or all of the heat transfer components 32, thus minimizing or eliminating the pressure drop introduced by the heat transfer components 32. FIGS. 2-9 depict translatable heat transfer components that may be translated between a first position and a second position to enable some or all of the air to bypass the heat transfer components. FIGS. 10-14 depict rotatable heat transfer components that may be rotated between a first position and a second position to enable some or all of the air to bypass the heat transfer components. Finally, FIGS. 15-16 depict removable heat transfer components that may be removed from the inlet 16 to enable some or all of the air to bypass the heat transfer components.

FIGS. 2A and 2B depict cross-sectional side views of the turbine inlet 16 depicting a first position and second position of reconfigurable heat transfer components 32 in accordance with an embodiment of the present invention. The heat transfer components 32 include a translatable set of coil panels 34 and a stationary set of coil panels 36. The coil panels 34 and 36 may include any number of coils embedded, integrated, or otherwise installed in a structure frame.

The inlet 16 includes an inlet duct 38, a transition duct 40, a filter housing 42 and the filter 30. Additionally, the inlet 16 may be supported by support structures 44. Air flows through the inlet in the direction generally indicated by arrow 46. As discussed above, air flows through the filter 30 and over the heat transfer components 32, during which the air may be heated or cooled by transferring heat to and from the heat transfer components 32 (and any fluid circulating through the heat transfer components 32). The cooled or heated air is accelerated by the transition duct 40 and exits the inlet 16 through the inlet duct 38.

The stationary coil panels 36 may be disposed in an upper portion of the filter housing 42 and the translatable coil panels 34 may be disposed in a lower portion of the filter housing 42 (e.g., vertically under the stationary coil panels 36). As shown in FIG. 2A, the inlet 16 may be in a first configuration in which the heat transfer components 32 are in a first position to maximize air flow over the heat transfer components 32. In this first position, the translatable coil panels 34 and stationary coil panels 36 are arranged to occupy all or substantially all of the cross-sectional area of the inlet 16 perpendicular (e.g., crosswise) to the air flow through the inlet 16.

As shown by arrows 47, any air flowing through the filter housing 42 passes over the heat transfer components 32 before exiting the inlet. In the first configuration, the heat transfer components 32 provide maximum heat transfer to/from the air as it flows through the inlet 16, as the air flows over both the stationary coil panels 36 and the translatable coil panels 34. Such a configuration may be used, for example, when the ambient temperature is relatively high and greater cooling is desired, or when the ambient temperature is relatively low and greater heating is desired (such as for anti-icing).

FIG. 2B depicts a second configuration of the inlet 16 in which the translatable coil panels 34 are translated to a second position to expose an air bypass region 48. As shown in FIG. 2B, the translatable coil panels 34 may be moved out of the air flow through the inlet 16. The translatable coil panels 34 may be moved in any direction perpendicular (e.g., crosswise) to the air flow or parallel (e.g., lengthwise) to the air flow. In this second configuration, some or all or the air entering the inlet 16 flows through the air bypass region 48, such that some or all of the air bypasses the stationary coil panels 36 completely. In the second configuration, the reduced cross-sectional area of the inlet 16 occupied by the heat transfer components 32, and the air bypass region 48, reduces or eliminates the added pressure drop of the heat transfer components 32. In some embodiments, the air bypass region 48 may include greater than approximately 5%, 15%, 25%, 50%, 75%, or 95% of the cross-sectional area of the inlet 16.

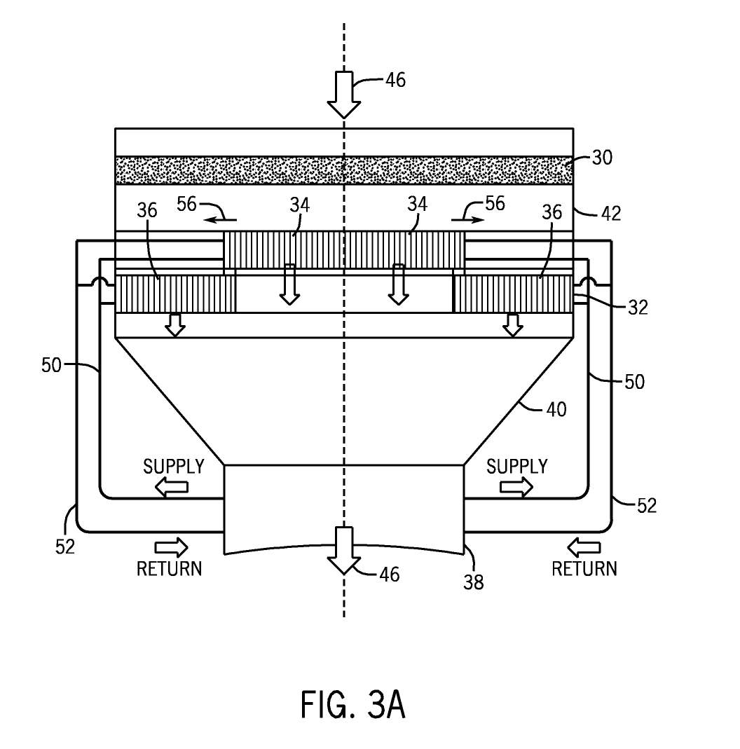

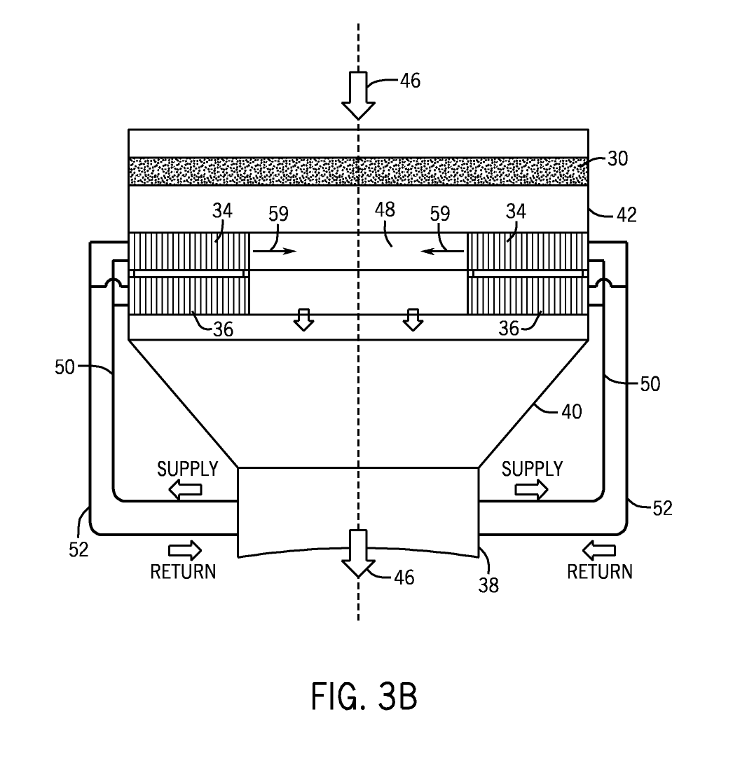

FIGS. 3A and 3B depict cross-sectional top views of the inlet 16 and the heat transfer components 32 discussed above in FIGS. 2A and 2B. FIGS. 3A and 3B depict the inlet duct 38, the transition duct 40, the filter housing 42 the filter 30, and the reconfigurable heat transfer components 32, e.g., stationary coil panels 36 and translatable coil panels 34. Additionally, FIGS. 3A and 3B also illustrate supply lines 50 (e.g., piping) to supply the heat transfer components 32 with a heat transfer fluid and return lines 52 (e.g., piping) to remove the heat transfer fluid from the heat transfer components 32. Together, the supply lines 50 and return lines 52 may circulate a heat transfer fluid through coils of the stationary coil panels 36 and translatable coil panels 34. In some embodiments, the supply lines 50 and return lines 52 may circulate fluid through external heat transfer units (e.g., evaporators and coils).

As discussed above, FIG. 3A depicts the first configuration in which heat transfer between the air entering the inlet and the coil panels 32 is maximized. In this first configuration, the translatable coil panels 34 are extended to create the maximum amount of cross-sectional area of the coil panels 32. As shown in FIG. 3A, any air entering the inlet will flow over the stationary coil panels 36 and/or the translatable coil panels 34.

FIG. 3B depicts the second configuration of the inlet 16 in which the translatable coil panels 34 are in a second position to expose air bypass region 48. In the second configuration, the translatable coil panels 34 are retracted in the directions indicated by arrows 56 so that the each of the translatable coil panels 34 are in an overlapping cross-sectional area with the stationary coil panels 36 (e.g., “behind” the stationary coil panels 36), creating air bypass region 48. The translatable coil panels 34 may be moved in any direction perpendicular (e.g., crosswise) through air flow through the inlet 16 or parallel (e.g., lengthwise) to the air flow through the inlet 16. In some embodiments, the translatable coil panels 34 may slidingly translate in the direction of arrows 56, such as by the mechanisms discussed below. Some or all of the air entering the inlet 16 flows through the air bypass region 48. As noted above, as compared to the first configuration, the air bypass region 48 reduces or eliminates the pressure drop added to air flowing through the inlet 16. Thus, the second configuration may be used when less heat transfer is desired, such as in moderate ambient temperatures. The reduced pressure drop in the second configuration of the inlet 16 enables the turbine engine to run at an increased efficiency as compared to the first configuration, while maintaining availability of the reconfigurable heat transfer components 32 for heat transfer. To restore the inlet 16 to the first configuration (and restore maximum heat transfer), the translatable heat transfer components may be translated back to the first position in the direction indicated by arrows 59. In other embodiments, the translatable coil panels 34 may be moved partially between the positions shown in FIGS. 3A and 3B to provide intermediate heat transfer capability with reduced pressure drop in the inlet 16. The translatable coil panels 34 may be in one row or multiple rows and may be partially or totally moved out of the path of the air flow

As discussed above, the inlet 16 may include supply lines 50 and return lines 52 for supply and return of heat transfer solution to and from the heat transfer components 32. To enable movement of the heat transfer components 32 while maintaining the connection of the heat transfer components 32 to the piping during extension of the panels, a suitable connection mechanism may be used between the lines 50 and 52 and the heat transfer components 32. In one embodiment, the connection mechanism may include a flexible hose and/or connection that may include a pulley system or other components for providing flexible (e.g., bendable, retractable, expandable, etc.). In such an embodiment, the flexible hose and/or connection may remain coupled to the translatable coil panels 34 during translation of the coil panels 34 between the first position and the second position.

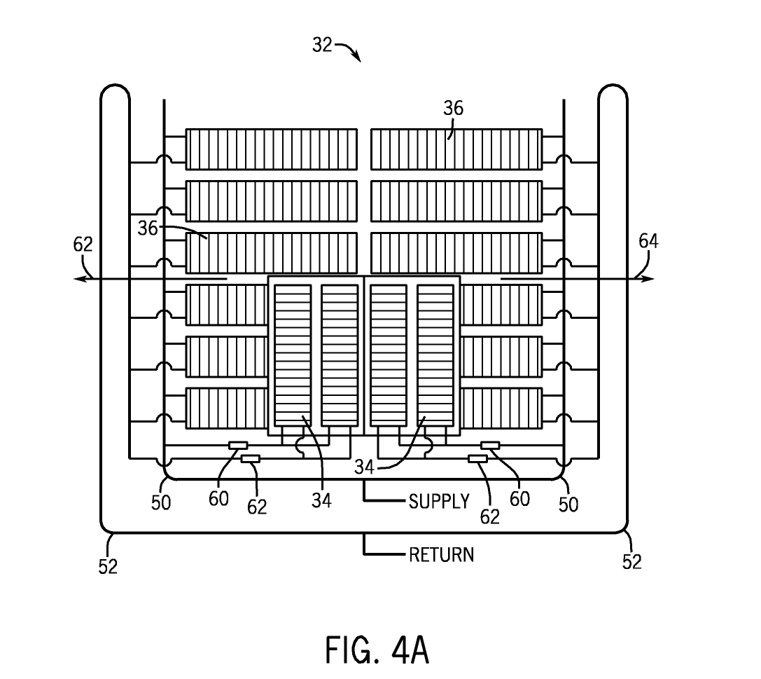

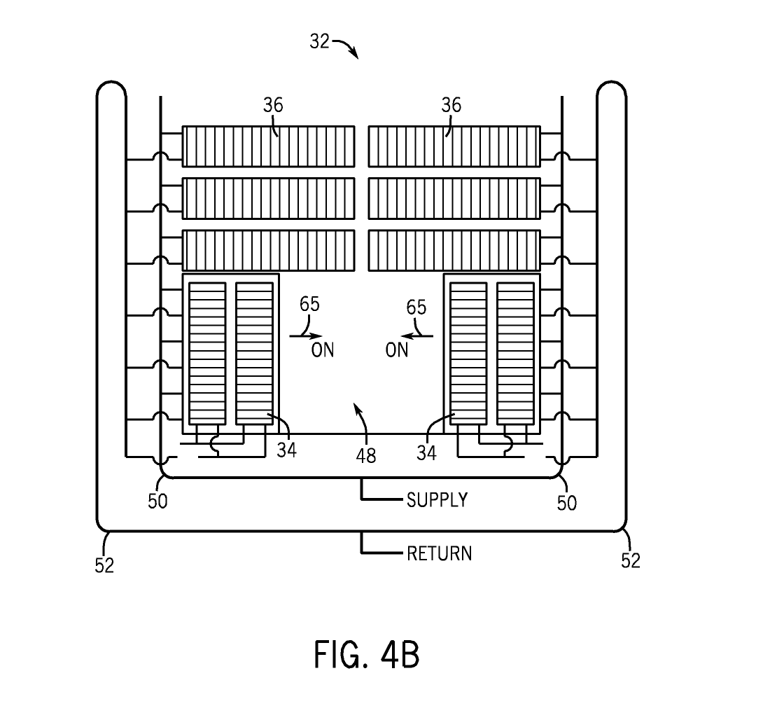

In other embodiments, the supply lines 50 and return lines 52 may be coupled to the translatable coil panels 34 by any suitable connection that enables manual disconnection of the lines 50 and 52 from the translatable coil panels 34. For example, such connections may include a quick release flange, a bolted flange, or any suitable connection. FIGS. 4A and 4B depict a connection system for heat transfer components 32, e.g., stationary coil panels 36 and translatable coil panels 34 in accordance with an embodiment of the present invention. The translatable coil panels 34 may be coupled to supply lines 50 by quick release connectors 60 and return lines 52 by quick release connectors 62. The stationary coil panels 36 may be coupled to the supply lines 50 and return lines 52 by any suitable connection, including such as quick release connectors or any suitable permanent connection (e.g., welding). In the first configuration, as shown in FIG. 4A, the translatable coil panels 34 are in the first position to provide maximum heat transfer between air flowing over the heat transfer components 32 and the heat transfer components 32 (and heat transfer fluid circulating through the components 32).

As discussed above, the translatable coil panels 34 may be translated to the second position in the direction indicated by arrows 64 to expose air bypass region 48 and reduce any additional pressure drop in the inlet 16. To transition to the second configuration of the inlet 16, the translatable coil panels 34 may be manually disconnected from the supply lines 50 by disconnecting the quick release connectors 60 and disconnected from the return lines 52 by disconnecting the quick release connectors 62. As shown in FIG. 4B, in the second configuration the translatable coil panels 34 are disconnected from the supply lines 50 and return lines 52. As the translatable coil panels 34 are no longer used for heat transfer, they do not receive a circulation (e.g., supply and return) of heat transfer fluid from the lines 50 and 52. The supply lines 50 and the return lines 52 may be blocked by a sealing portion of the quick release connectors 60 and 62 respectively, or alternative or additional sealing components may be coupled to the disconnected supply lines 50 and return lines 52, such as by a blind flange, valve, or other component. The stationary coil panels 36 may remain connected to the supply lines 50 and return lines 52 to receive circulated heat transfer fluid. As shown in FIG. 4B and arrows 65, the translatable coil panels 34 may be translated to the first position to provide maximum heat transfer in the inlet 16. Thus, the supply lines 50 may be reconnected to the translatable coil panels 34 by the connector 60 and the return lines 52 may be reconnected to the translatable coil panels 34 by the connector 62.

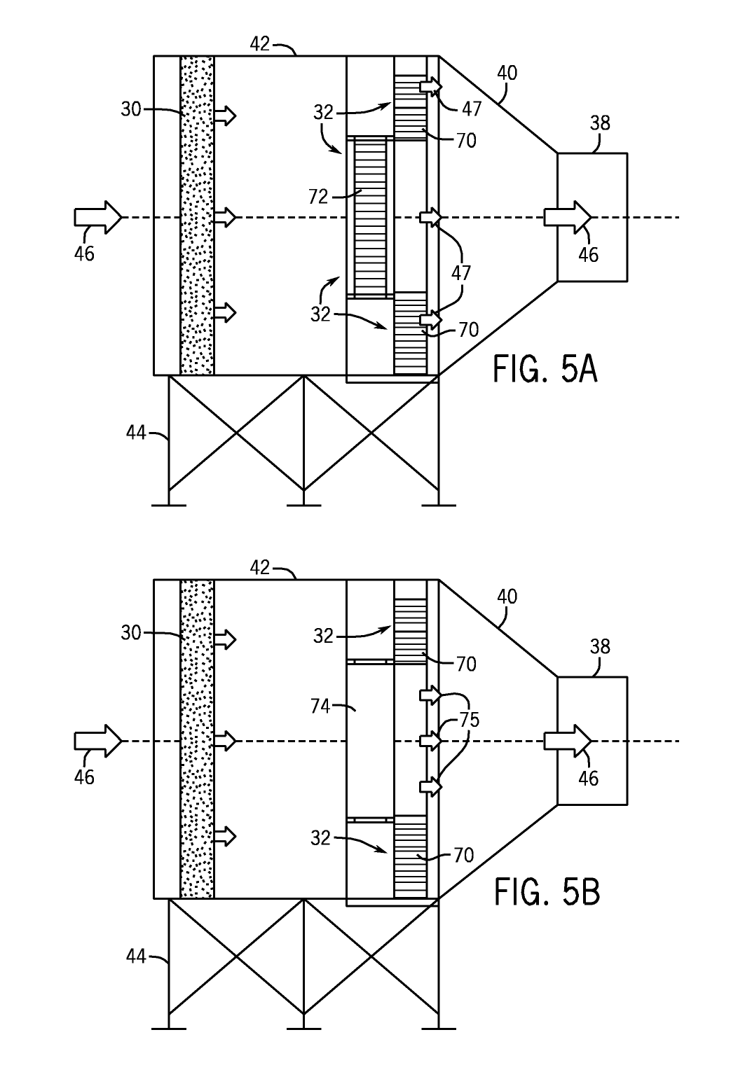

FIGS. 5A and 5B depict cross-sectional side views of the turbine inlet 16 depicting a first position and second position of reconfigurable heat transfer components 32 in accordance with another embodiment of the present invention. As described above, the inlet 16 includes the inlet duct 38, the transition duct 40, the filter housing 42, the filter 30, and reconfigurable heat transfer components 32, e.g., stationary coil panels 70 arranged at the upper portion and lower portion of the filter housing 42, and translatable coil panels 72 arranged vertically between the stationary coil panels 70. Air flows through the inlet 16 in the direction indicated by arrows 46. In the first configuration of the inlet 16, as shown in FIG. 5A, the translatable coil panels 72 may be in a first position such that some or all of the inlet air flows over the heat transfer components 32, as illustrated by arrows 47. In this first configuration, most or all of the cross-sectional area available for air flow is occupied by the heat transfer components 32, such that heat transfer between the air and the heat transfer components 32 (and any heat transfer fluid circulating through the heat transfer components 32) is maximized. As noted above, however, this first configuration may add a pressure drop to inlet air.

FIG. 5B depicts a second configuration of the inlet 16 in which the translatable coil panels 72 are translated to a second position to create an air bypass region 74. The translatable coil panels 72 may be translated in any direction perpendicular (e.g., crosswise) to air flow in the inlet 16. The air bypass region 74, in combination with the reduced cross-sectional area of the heat transfer components 32, reduces or eliminates any pressure drop added by the heat transfer components 32. After the air enters the inlet 16, some or all of the air may flow through the air bypass region 74, bypassing the heat transfer components 32, as illustrated by arrows 75. In contrast to the embodiment described above in FIGS. 2-4, the air bypass region 74 is created vertically between the stationary coil panels 70. In some embodiments, the air bypass region 74 may include greater than approximately 5%, 15%, 25%, 50%, 75%, or 95% of the cross-sectional area of the inlet 16. The arrangement of the translatable coil panels 72 relative to the stationary coil panels 70 (e.g., whether the translatable coil panels 72 are arranged vertically above, below, or between the stationary coil panels) may provide for selection of the cross-sectional area occupied by the air bypass region 74 and/or the heat transfer components 32. In other embodiments, the translatable coil panels 72 may be moved partially between the positions shown in FIGS. 5A and 5B to provide intermediate heat transfer capability with reduced pressure drop in the inlet 16.

As discussed above, to enable translation of the translatable coil panels 72 while maintaining the connection of the translatable coil panels 72 to the supply and return lines, a suitable connection mechanism may be used between the supply and return lines and the coil panels 32. In one embodiment, the connection mechanism may include a flexible hose and/or connection that may include a pulley system such that the flexible hose and/or connection may remain coupled to the translatable coil panels 72 during extension and retraction of the coil panels 72.

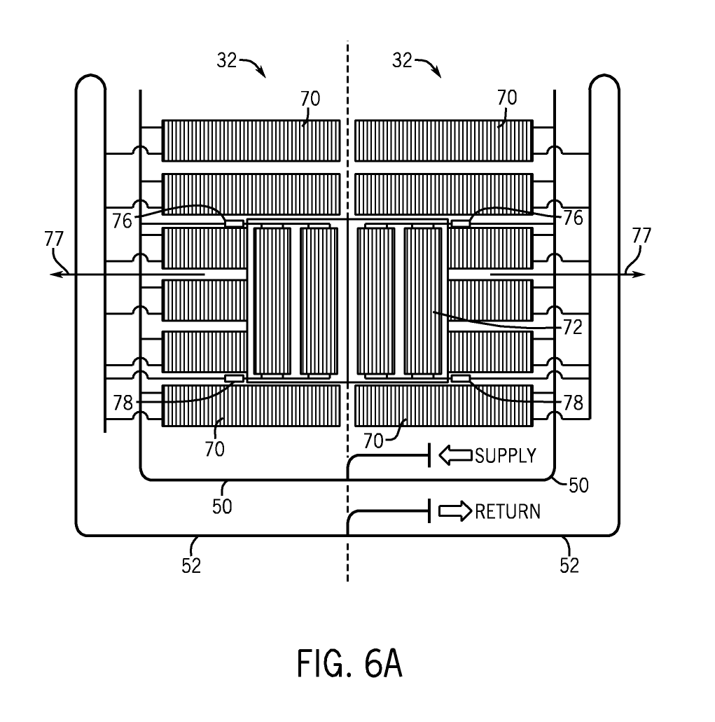

In other embodiments, the supply and return lines may be coupled to the translatable coil panels 72 by any suitable connection that enables manual disconnect of the lines from the translatable coil panels 72. For example, such connections may include a quick release flange, a bolted flange, or any suitable connection. FIGS. 6A and 6B depict a connection system for reconfigurable heat transfer components 32 having stationary coil panels 70 and translatable coil panels 72 in accordance with an embodiment of the present invention. The translatable coil panels 72 may be coupled to supply lines 50 by quick release connectors 76 and return lines 52 by quick release connectors 78. The stationary coil panels 70 may be coupled to the supply lines 50 and return lines 52 by any suitable connection, including any suitable permanent connection (e.g., welding). In the first configuration, as shown in FIG. 6A, the translatable coil panels 72 are in the first position to provide maximum heat transfer between air flowing over the heat transfer components 32 and the heat transfer components 32 (and heat transfer fluid).

As discussed above, the translatable coil panels 72 may be translated to a second position in the direction indicated by arrows 77 to expose air bypass region 74 and reduce pressure drop in the inlet 16. Again, as discussed above, to transition to the second configuration, the translatable coil panels 72 may be manually disconnected from the supply lines 50 by disconnecting the quick release connectors 76 and disconnected from the return lines 52 by disconnecting the quick release connectors 78. As shown in FIG. 6B, in the second configuration the translatable coil panels 72 are disconnected from the supply lines 50 and return lines 52 and retracted behind some of the stationary coil panels 70, such that the cross-sectional area of the translatable coil panels 72 partially overlaps the cross-sectional area of the stationary coil panels 70. The supply lines 50 and the return lines 52 may be blocked by a sealing portion of the quick release connectors 76 and 78 respectively, or alternative or additional sealing components may be coupled to the terminated supply lines 50 and return lines 52, such as a blind flange, valve, or other components. The stationary coil panels 70 remain connected to the supply lines 50 and return lines 52 to receive the circulated heat transfer fluid. The translatable coil panels 72 may be reconnected to the supply and return lines 50 and 52 using the quick release connectors when reconfiguring the translatable coil panels to the first configuration (shown by arrows 79 in FIG. 6B).

As described above, the embodiments depicted in FIGS. 2-6 include translatable coil panels that translate from a first position (first configuration of the inlet 16) to a second position (second configuration of the inlet 16). The translatable coil panels may be retracted by any suitable drive train mechanism that enables movement of the coil panels in the desired directions. For example, such drive train mechanisms may include a chain drive, a ball screw mechanism, a hydraulic mechanism, a cog belt mechanism, a pulley belt mechanism, an electric mechanism, a pneumatic mechanism, or any suitable combination thereof. Such drive train mechanisms may be selected based on availability, cost, weight, speed, reliability, complexity, maintenance (e.g., lubrication requirements).

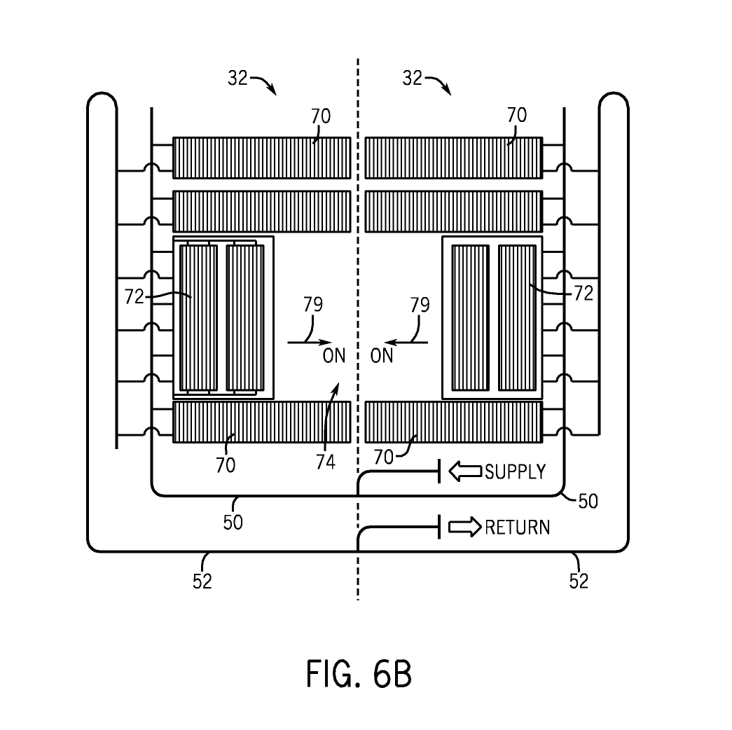

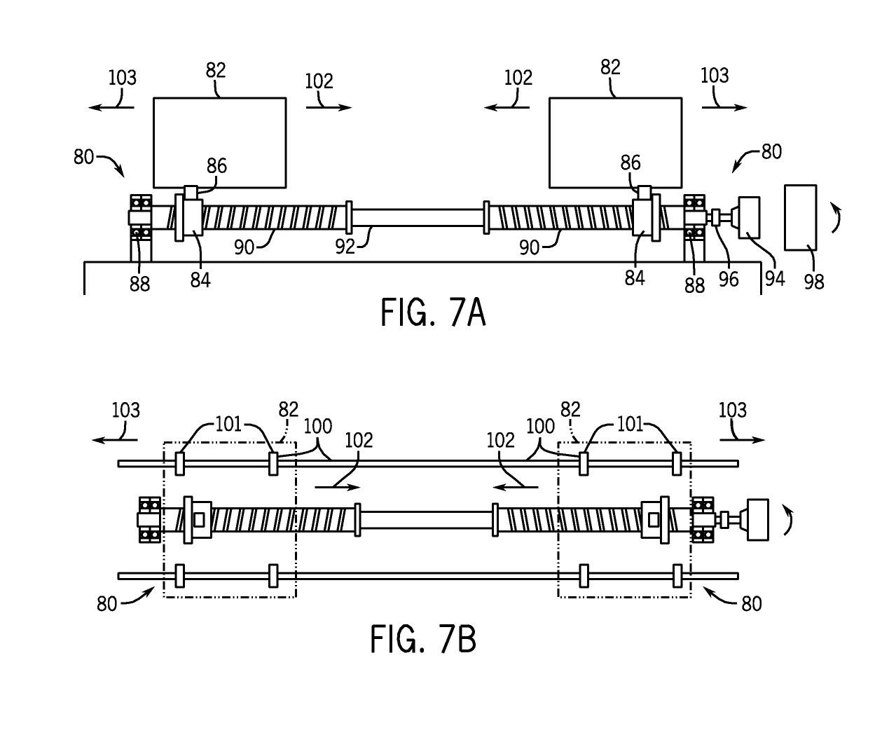

FIGS. 7A and 7B depict front and top views respectively of a ball screw mechanism 80 for moving translatable coil panels 82 in accordance with an embodiment of the present invention. As shown in FIG. 7A, the translatable coil panels 82 may be coupled to ball nuts 84 by couplings 86. The couplings 86 may removably or permanently couple the translatable coil panels 82 to the ball nuts 84 and ball screw mechanism 80. The ball screw mechanism 80 may include support bearings 88, and the ball nuts 84 may be rotatably disposed on ball screw bars 90. The ball screw bars 90 may be connected via an inter-shaft 92. The ball screw mechanism 80 includes a motor 94 (e.g., electric, hydraulic, or pneumatic motor) coupled to the ball screw bars 90 and the inner shaft 92 by a coupling 96. The motor 94 may receive power from, and may be controlled by, a control box 98.

FIG. 7B depicts a top view of the ball screw mechanism 80 in accordance with an embodiment of the present invention. As more clearly shown in the top view of FIG. 7B, the translatable coil panels 82 may also be coupled to ball linear guides 100 and ball linear guide couplings 101. To translate the translatable coil panels in the direction indicated by arrows 102, the motor 94 may rotate the ball screw bars 90 via the couplings 96 and the support bearings 88. As a ball screw bars 90 rotate, such as in a clockwise direction, the ball nuts 84 move along the ball screw bars 90, moving the coil panels 82 in the directions indicated by arrows 102. To retract the translatable coil panels 82, the motor 94 may rotate the ball screw bars 90 in a counterclockwise direction, such that the ball nuts 84 (and translatable coil panels 82) translate in the directions indicated by arrows 103. In this manner, the ball screw mechanism 80 may enable translation (e.g., sliding) of the translatable coil panels 82 to expose an air bypass region in the inlet 16.

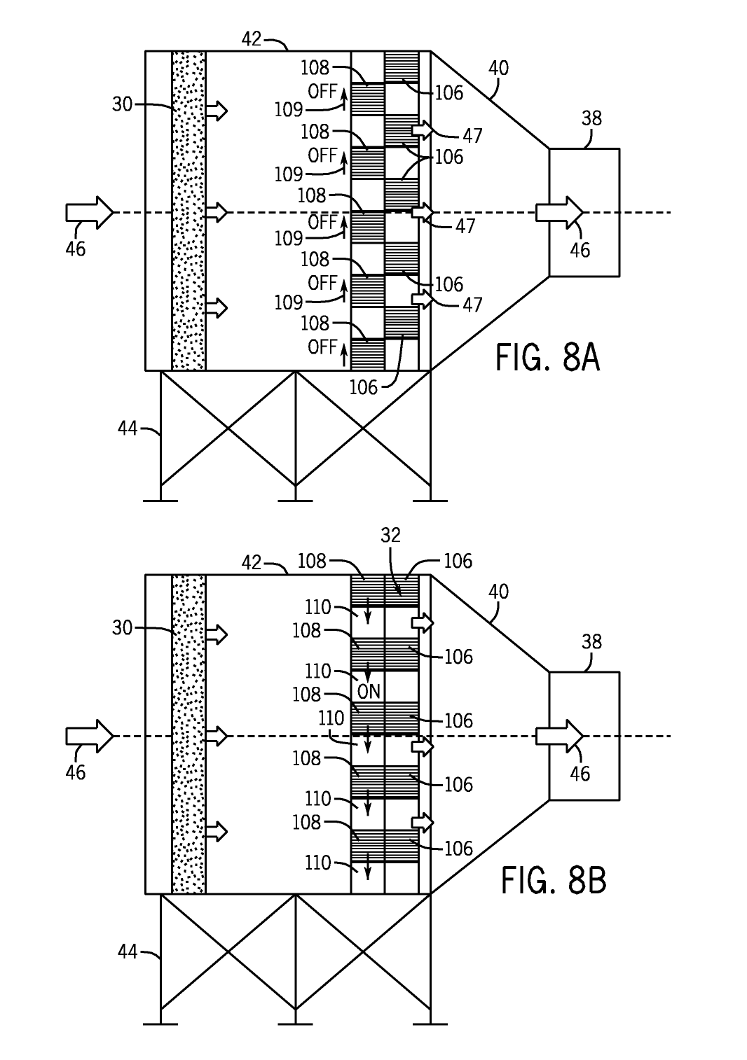

FIGS. 8A and 8B depict cross-sectional side views of the turbine inlet 16 depicting a first position and second position of reconfigurable heat transfer components 32 in accordance with another embodiment of the present invention. As shown in FIG. 8A, the heat transfer components 32 may include multiple stationary coil panels 106 and multiple translatable coil panels 108. Each of the translatable coil panels 108 may be vertically disposed next to each of the stationary coil panels 106. As noted above, the inlet 16 includes the inlet duct 38, the transition duct 40, the filter housing 42, and the filter 30. Additionally, the inlet 16 may be supported by support structures 44. Air flows through the inlet in the direction generally indicated by arrow 46.

In the first configuration of the inlet 16, as shown in FIG. 8A, the translatable coil panels 108 may be placed in a first position to maximize air flow over the heat transfer components 32. As shown by arrows 47, any air flowing through the filter housing 42 passes over the heat transfer components 32 before exiting the inlet 16. In the first configuration, the heat transfer components 32 provide maximum heat transfer to/from the air as it flows through the inlet 16, as the air flows over both the stationary coil panels 106 and the translatable coil panels 108.

In the second configuration, as shown in FIG. 8B, the translatable coil panels 108 may be translated (as shown by arrows 109) to a second position to expose multiple air bypass regions 110. In some embodiments, any number of air bypass regions 110 may be exposed, such as greater than 2, 5, 10, 15, or 20 openings. The translatable coil panels 108 may be translated in a generally vertical direction such that the cross-sectional area occupied by the translatable coil panels 108 substantially overlaps the cross-sectional area occupied by the stationary coil panels 106.

In this second configuration, some or all of the air entering the inlet 16 flows through the air bypass regions 110, such that some or all of the air bypasses the heat transfer components 32. In the second configuration, the reduced cross-sectional area occupied by the heat transfer components 32 and the multiple air bypass regions 110 reduces or eliminates any pressure drop added by the heat transfer components 32. As noted above, selection of the various arrangements and sizes of the translatable coil panels that provide for selection of the cross-sectional area occupied by the air bypass region regions. In some embodiments, the air bypass regions may include greater than approximately 5%, 15%, 25%, 50%, 75%, or 95% of the available cross-sectional area of the inlet 16.

As noted above, the translatable coil panels 108 may be translated by any suitable drive train mechanism that enables movement of the coil panels in the desired directions. For example, such drive train mechanisms may include a chain drive, a ball screw mechanism, a hydraulic mechanism, a cog belt mechanism, a pulley belt mechanism, an electric mechanism, a pneumatic mechanism, or any suitable combination thereof.

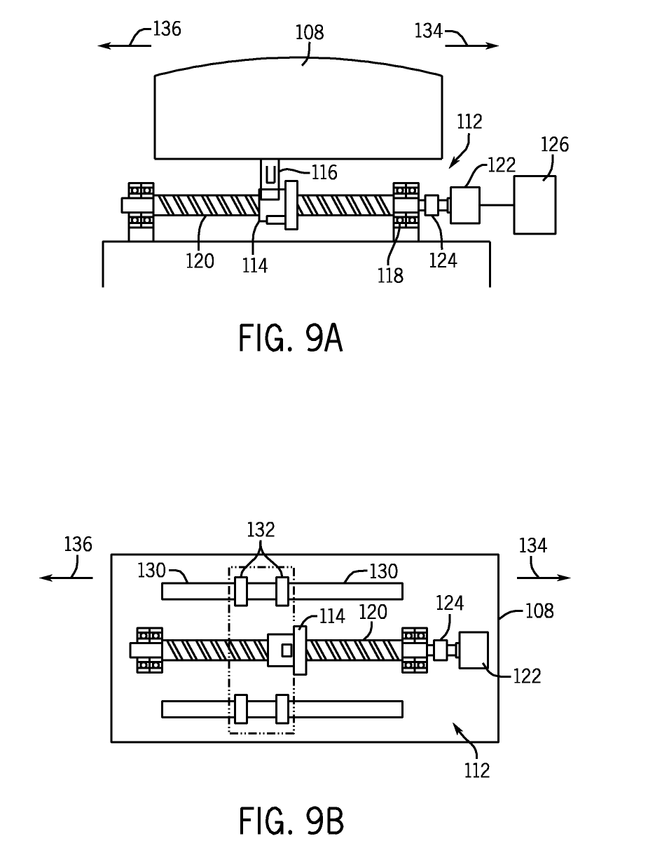

FIGS. 9A and 9B depict front and top views respectively of a ball screw mechanism 112 for moving translatable coil panels 108 in accordance with an embodiment of the present invention. As shown in FIG. 9A, the translatable coil panels 108 may be coupled to a ball nut 114 by coupling 116. The coupling 116 may removably or permanently couple the translatable coil panel 110 to the ball nut 114 and ball screw mechanism 112. The ball screw mechanism 112 may include support bearings 118, and the ball nut 114 rotatably disposed on a ball screw bar 120. The ball screw mechanism 112 includes a motor 122 (e.g., electric, hydraulic, or pneumatic motor) coupled to the ball screw bar 120 and by a coupling 124. The motor 122 may receive power from, and may be controlled by, a control box 126.

FIG. 9B depicts a top view of the ball screw mechanism 112 in accordance with an embodiment of the present invention. The translatable coil panels 108 may also be coupled to ball linear guides 130 and ball linear guide couplings 132. To move the translatable coil panel 108 in the direction indicated by arrows 134 and 136, the motor 122 may rotate the ball screw bar 120 through via the coupling 124 and the support bearings 118. As the ball screw bar 120 rotates, such as in a clockwise direction, the ball nut 114 translates along the ball screw bar 120, moving the translatable coil panel 108 in the direction indicated by arrows 134. To retract the translatable coil panel 108, the motor 122 may rotate the ball screw bar 120 in a counterclockwise direction, such that the ball nut 114 translates in the direction indicated by arrow 136. In this manner, the ball screw mechanism 112 may enable movement of the translatable coil panel 108 to expose an air bypass region in the inlet 16. In some embodiments, multiple translatable coil panels may be coupled to the ball screw bar 120 to enable creation of multiple air bypass regions, such as in the second configuration depicted in FIG. 8B. In other embodiments, multiple ball screw bars 120 may be arranged along a single axis so that each translatable coil panel 108 may be coupled to a single ball screw bar 120.

In other embodiments, the inlet 16 may include rotatable heat transfer components that rotate between a first position and a second position to create air bypass regions. In such embodiments, the heat transfer components may rotate around different axes of rotation (e.g., to rotate between positions crosswise or lengthwise to the airflow) depending on the arrangement of the heat transfer components.

FIGS. 10A and 10B are cross-sectional top views of the turbine inlet 16 depicting a first position and second position of reconfigurable heat transfer components 32, e.g., rotatable coil panels 140, in accordance with another embodiment of the present invention. As described above, the inlet 16 includes the inlet duct 38, the transition duct 40, the filter housing 42, the filter 30, and the heat transfer components 32, e.g., rotatable coil panels 140. The rotatable coil panels 140 rotate between a first position, as shown in FIG. 10A, and a second position, as shown in FIG. 10B. The rotatable coil panels 140 may rotate around a stationary component 146, such as a shaft. Air flows through the inlet 16 in the direction indicated by arrows 46. In this first configuration of the inlet 16, most or all of the cross-sectional area available for air flow is occupied by the coil panels 140, such that heat transfer between the air and the heat transfer components (and heat transfer fluid) is maximized. Thus, as shown by arrows 47 in FIG. 10A, most or all of the inlet air flows over the rotatable coil panels 140. As noted above, however, such a configuration may add larger pressure drop to the inlet air.

In the second configuration of the inlet 16, as shown in FIG. 10B, the rotatable coil panels 140 may be rotated to a second position, as shown by arrows 148 of FIG. 10A, to create air bypass region 150. For example, as shown in FIGS. 10 A and 10B, the rotatable coil panels 140 may rotate away and toward one another. In some embodiments, the air bypass region 150 may include greater than approximately 5%, 15%, 25%, 50%, 75%, or 95° A of the cross-sectional area of the inlet 16. After the air enters the inlet 16, some or all of the air will flow through the air bypass region 150, bypassing the heat transfer components 32 and reducing or eliminating any pressure drop caused by the rotatable coil panels 140. To rotate the coil panels 140 to the first position, the rotatable coil panels 140 may be rotated around the shaft 146 in the direction indicated by arrows 151 of FIG. 10B.

FIG. 11 depicts a cross-sectional front view of the inlet 16 and the rotatable coil panels 140 in accordance with an embodiment of the present invention. As shown in FIG. 11, the rotatable coil panels 140 may be divided into two groups 152 and 154, with each group rotating around a stationary component 146. The axes of rotation are indicated by dashed lines 156. Thus, in the embodiment depicted in FIG. 11, each rotatable coil panel 140 may rotate through a horizontal plane of the inlet 16 to expose air bypass region 150.

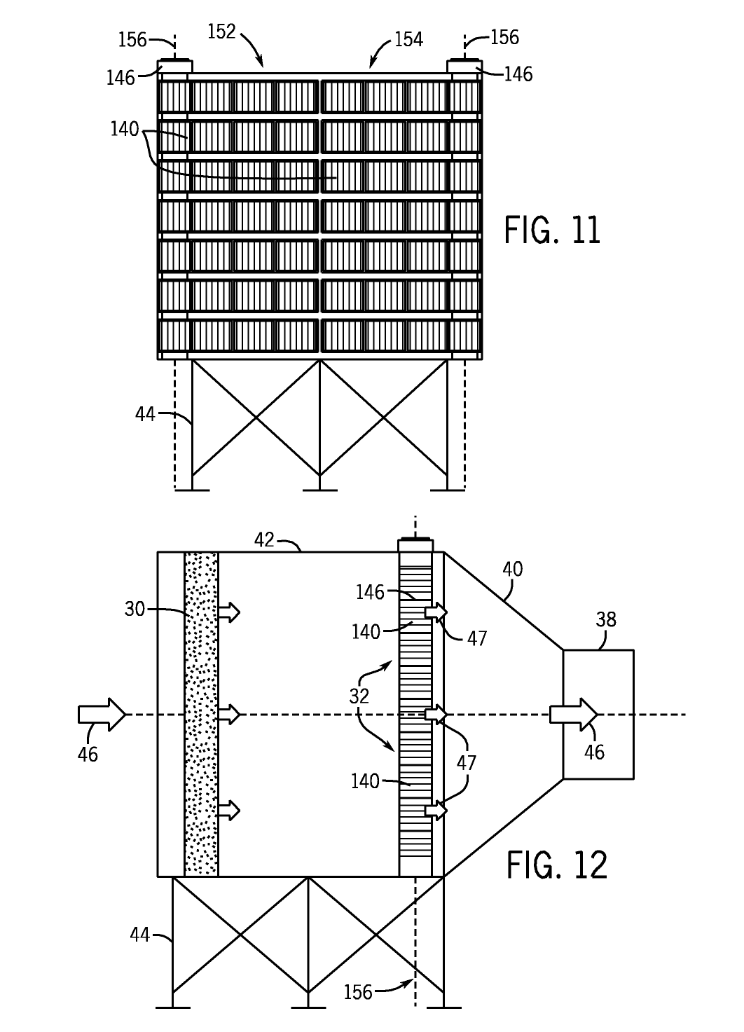

FIG. 12 depicts a side view of the inlet 16 in the first configuration having rotatable coil panels 140 in accordance with an embodiment of the present invention. As shown in FIG. 12, the rotatable coil panels 140 are in a first position to provide maximum heat transfer between the rotatable coil panels 140 and air flowing though the inlet 16. In this configuration, all or substantially all of the air flowing through the inlet may flow over the reconfigurable heat transfer components 32, as indicated by arrows 47. As described above the rotatable coil panels 140 may rotate around the axes of rotation 156 between a first position and a second position to expose the air bypass region 150.

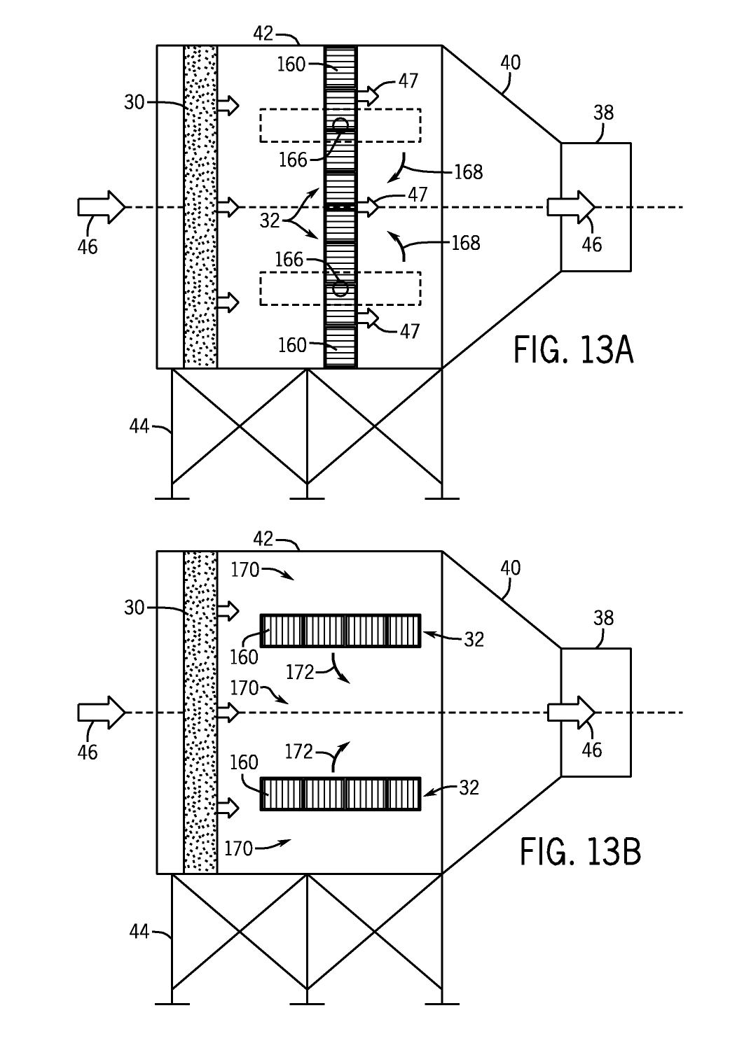

FIGS. 13A and 13B are cross-sectional top views of the inlet 16 depicting a first position and second position of reconfigurable heat transfer components 32, e.g., rotatable coil panels 160, in accordance with another embodiment of the present invention. As described above, the inlet 16 includes the inlet duct 38, the transition duct 40, the filter housing 42, the filter 30, and the heat transfer components 32, e.g., rotatable coil panels 140. The rotatable coil panels 160 rotate between a first position in which the rotatable coil panels 160 are perpendicular (e.g., crosswise) to the air flow through the inlet 16, and a second position in which the rotatable coil panels 160 are parallel (e.g., lengthwise) to the air flow through the inlet 16. In such an embodiment, the rotatable coil panels 160 may rotate around stationary components 166, e.g. a shaft, disposed perpendicular to and extending through the rotatable coil panels 160. Thus as shown in FIG. 13A, the stationary components 166 are inserted through a central region (e.g., center or off-center) of rotatable coil panels 160. In this first configuration, most or all of the cross-sectional area available for air flow is occupied by the coil panels 160, such that heat transfer between the air and the coil panels 160 is maximized. Thus, most or all of the inlet air flows over the heat transfer components 32, as shown by arrows 47.

In the second configuration, as shown in FIG. 13B, the rotatable coil panels 160 may be rotated to a second position, as shown by arrows 168 of FIG. 10A, to create air bypass regions 170. For example, the rotatable coil panels may be rotated 90 degrees to be in line with airflow through the inlet 16. In some embodiments, air bypass regions 170 may include greater than approximately 5%, 15%, 25%, 50%, 75%, or 95% of the cross-sectional area of the inlet 16. After the air enters the inlet 16, some or all of the air will flow through the air bypass region 170, bypassing most or all of the heat transfer components 32, thus eliminating or reducing any pressure drop caused by the rotatable coil panels 160. To move the rotatable coil panels 160 to the first position (and reconfigure the inlet 16 to the first configuration), rotatable coil panels 160 may be rotated around the stationary components 164 as illustrated by arrows 172 of FIG. 13B.

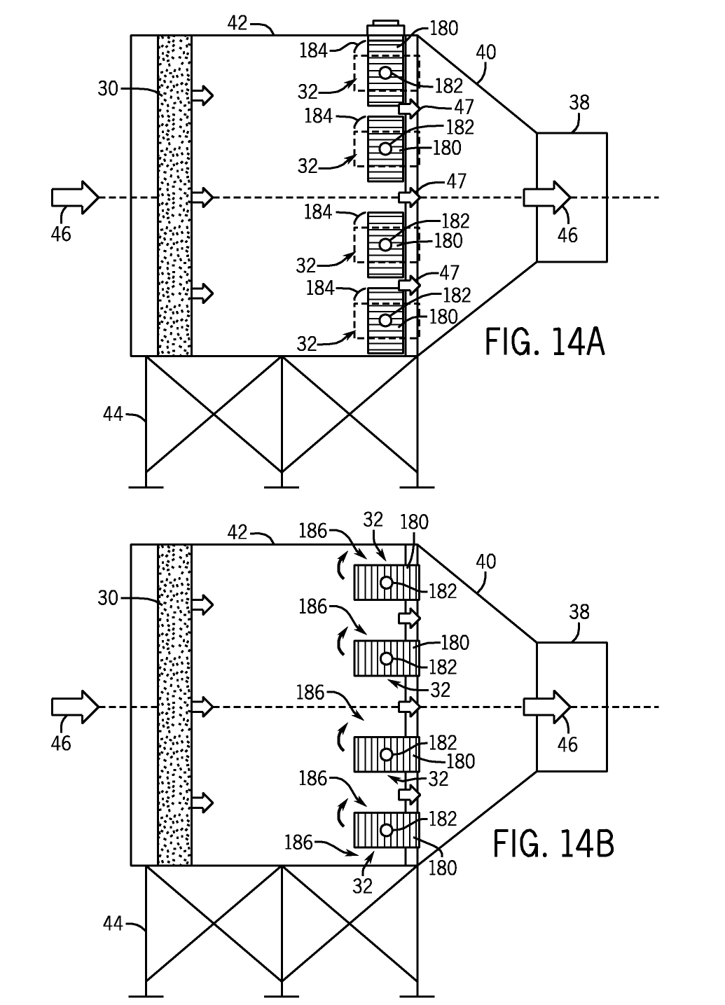

FIGS. 14A and 14B are cross-sectional top views of the inlet 16 depicting a first position and second position of reconfigurable heat transfer components 32, e.g., rotatable coil panels 180, in accordance with another embodiment of the present invention. As shown in FIGS. 14A and 14B, multiple rotatable coil panels 180 may be vertically disposed in the filter housing 42 to occupy most of the cross-sectional area of the filter housing 42. As noted above, the inlet 16 includes the inlet duct 38, the transition duct 40, the filter housing 42, and the filter 30. Additionally, the inlet 16 may be supported by support structures 44. Air flows through the inlet in the direction generally indicated by arrow 46.

As discussed above, air flows through the filter 30 and over the heat transfer components 32, during which the air may be heated or cooled by transferring heat to and from the heat transfer components 32 (and heat transfer fluid). The rotatable coil panels 180 rotate between a first position shown in FIG. 14A, in which the rotatable coil panels 180 are perpendicular (e.g., crosswise) to the air flow, and a second position shown in FIG. 14B in which the rotatable coil panels 180 are parallel (e.g., lengthwise) to the air flow. In such an embodiment, the rotatable coil panels 180 may rotate around stationary components 182, e.g. a shaft, disposed perpendicular to and extending through the rotatable coil panels 180. In the embodiment shown in FIGS. 14A and 14B, the stationary components 182 may be inserted horizontally through a central region (e.g., center or off-center) of rotatable coil panels 180. In this first configuration, most or all of the cross-sectional area available for air flow is occupied by the coil panels 180, such that heat transfer between the air and the coil panels 180 is maximized. As shown by arrows 47 of FIG. 14A, most or all of the air flowing through the inlet 16 may flow through the heat transfer components 32.

As shown in FIG. 14B, in a second configuration of the inlet 16 the rotatable coil panels 180 may be rotated to a second position, as shown by arrows 184 of FIG. 14A, to create air bypass regions 186. In some embodiments, any number of air bypass regions 186 may be exposed, such as greater than 2, 5, 10, 15, or 20 openings. After the air enters the inlet 16, some or all of the air will flow through the air bypass regions 186, thus eliminating or reducing any pressure drop caused by the rotatable coil panels 180. To move the rotatable coil panels 180 to the first position (and configure the inlet 16 in the first configuration), rotatable coil panels 180 be rotated around the stationary components 182 as illustrated by arrows 186 of FIG. 14B.

It should be appreciated that the rotation of the rotatable coil panels described above in FIGS. 12-14 may be manual, automatic, or some combination thereof. For example, the rotatable coil panels may be manually rotated by a technician between the first position and the second position. In other embodiments, the rotatable coil panels may be mechanically, hydraulically, electrically, pneumatically, or otherwise rotated between the first position and second position. Additionally it should be appreciated that the rotatable coil panels may be connected to supply lines and return lines for the circulation of heat transfer fluid through the coils of the coil panels. As described above, the connections to the supply lines and return lines may be flexible connectors, or may be quick release connectors or bolt connectors that are disconnected when the rotatable coil panels are moved to the second position and the inlet 16 is in the second configuration.

In other embodiments, the turbine inlet 16 may include removable heat transfer components that may be removed from the inlet to create air bypass regions. FIGS. 15 and 16 depict embodiments of the turbine inlet 16 having reconfigurable heat transfer components 32 that may be removed or installed to change the inlet 16 between a first configuration and a second configuration.

FIGS. 15A and 15B are cross-sectional side views of the turbine inlet 16 depicting reconfigurable heat transfer components 32, e.g., removable coil panels 190 and stationary coil panels 192, in accordance with an embodiment of the present invention. As described above, the inlet 16 includes the inlet duct 38, the transition duct 40, the filter housing 42, the filter 30, and the heat transfer components, e.g., coil panels 32. The heat transfer components 32 depicted in FIGS. 15A and 15B include stationary coil panels 192 arranged at the upper portion and lower portion of the filter housing 42, and removable coil panels 190 arranged vertically between the stationary coil panels 192. The inlet 16 may include a frame or other structure 44 to secure the stationary coil panels 192 and the removable coil panels 190. In the first configuration shown in FIG. 15A, air flows through the inlet 16 in the direction indicated by arrows 46 and over the heat transfer components 32 as shown by arrows 47. In the first configuration, most or all of the cross-sectional area available for air flow is occupied by the heat transfer components 32, such that heat transfer between the air and the coil panels 32 is maximized. In some embodiments, there may be any number of removable coil panels 192, such as 1-20, or greater than 2, 3, 4, 5, or more coil panels 192.

FIG. 15B depicts the removable coil panels 190 in the process of removal but not yet completely removed. As shown in FIG. 15B, the removable coil panels 190 may be removed from the inlet 16 to create air bypass region 194. In this second configuration, the air bypass region 194 is created vertically between the stationary coil panels 192. The air bypass region 194, in combination with the reduced cross-sectional area of the heat transfer components 32 (the remaining stationary coil panels 192), reduces or eliminates any pressure drop added by the heat transfer components 32. After the air enters the inlet 16, some or all of the air will flow through the air bypass region 194. The removable coil panels 190 may be manually removed completely from the inlet 16 when changing the inlet 16 to the second configuration. To restore the inlet 16 to the first configuration (and provide maximum heat transfer between the heat transfer components 32 and the air flow in the inlet 16), the removable coil panels 190 may be manually installed in the air bypass region 194.

FIGS. 16A and 16B are cross-sectional side views of the turbine inlet 16 depicting reconfigurable heat transfer components 32, e.g., removable coil panels 200 and stationary coil panels 202, in accordance with an embodiment of the present invention. As described above, the inlet 16 includes the inlet duct 38, the transition duct 40, the filter housing 42, and the filter 30, wherein the inlet 16 may be supported by support structures 44. Air flows through the inlet in the direction generally indicated by arrow 46. In the first configuration depicted in FIG. 16A, the removable coil panels 200 may be installed in the inlet 16 to maximize the cross-sectional area of the heat transfer components 32 and provide maximum heat transfer. In the first configuration, each of the removable coil panels 200 may be installed adjacent to one of the stationary coil panels 202. In the first configuration, most or all of the cross-sectional area available for air flow is occupied by the heat transfer components 32, such that most or all of the air flowing through the inlet 16 will flow over the heat transfer components 32, as shown by arrows 47.

FIG. 16B depict a second configuration of the inlet 16 in which the removable coil panels 200 are removed from the inlet 16. In this second configuration, the removable coil panels 200 may be removed from the inlet 16 to expose multiple air bypass regions 204. Each of the multiple air bypass regions 204 may be exposed between each of the stationary coil panels 200. In some embodiments, any number of air bypass regions 204 may be exposed, such as greater than 2, 5, 10, 15, or 20 openings. After the air enters the inlet 16, some or all of the air may flow through the air bypass regions 204, bypassing the stationary coil panels 200. As discussed above, the second configuration reduces or eliminates any pressure drop added by the heat transfer components 32 in the inlet 16. The removable coil panels 200 may be manually removed completely from the inlet 16 when changing the inlet 16 to the second configuration. To restore the inlet 16 to the first configuration (and provide maximum heat transfer between the heat transfer components 32 and the air flow in the inlet 16), the removable coil panels 200 may be manually installed in the air bypass regions 204.

The removable coil panels described above in FIGS. 15 and 16 may be connected to supply lines and return lines for the circulation of heat transfer fluid through the coils of the coil panels or panels. As described above, the connections to the supply lines and return lines may be flexible connectors, or may be quick release connectors or bolt connectors that are disconnected when the rotatable coil panels or panels are moved to the second position and the inlet 16 is in the second configuration.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system, comprising:
a turbine air intake, comprising:
one or more reconfigurable heat transfer components configured to exchange heat with an airflow,
wherein each reconfigurable heat transfer component is reconfigurable between a first position and a second position, wherein the second position opens a bypass region for the airflow.

2. The system of claim 1, comprising one or more stationary heat transfer components.

3. The system of claim 2, wherein the one or more reconfigurable heat transfer components are disposed between the one or more stationary heat transfer components.

4. The system of claim 3, wherein each reconfigurable heat transfer component overlaps one of the one or more stationary heat transfer components in the second position.

5. The system of claim 1, wherein the one or more reconfigurable heat transfer components are translatable crosswise to the airflow from the first position to the second position.

6. The system of claim 1, wherein the one or more reconfigurable heat transfer components are rotatable from the first position to the second position, wherein each reconfigurable heat transfer component is oriented crosswise across the airflow in the first position and each reconfigurable heat transfer component is oriented lengthwise along airflow in the second position.

7. The system of claim 1, wherein the one or more reconfigurable heat transfer components are removable from the turbine air intake, wherein the reconfigurable heat transfer components are installed in the turbine air intake in the first position and removed in the second position.

8. The system of claim 1, comprising a supply line configured to supply heat transfer fluid to the one or more reconfigurable heat transfer components and a return line configured to return heat transfer fluid from the one or more reconfigurable heat transfer components.

9. The system of claim 8, wherein the supply line and the return line are coupled to the one or more reconfigurable heat transfer components by a plurality of removable couplings, wherein in the second position the removable couplings are disconnected.

10. The system of claim 8, wherein the supply line and the return line comprise flexible lines.

11. The system of claim 1, comprising a gas turbine engine coupled to the turbine air intake.

12. A turbine air intake, comprising:
a reconfigurable heat exchanger, wherein the reconfigurable heat exchanger comprises a first configuration and a second configuration, wherein the second configuration opens a bypass for airflow.

13. The turbine air intake of claim 12, wherein the reconfigurable heat transfer exchanger comprises at least one movable heat exchange component that is movable from the first configuration to the second configuration to open the bypass.

14. The turbine air intake of claim 13 wherein the at least one movable heat exchange components is configured to move crosswise to the airflow from the first configuration to the second configuration.

15. The turbine air intake of claim 13, wherein the at least one movable heat exchange components is configured to rotate crosswise to the airflow from the first configuration to the second configuration.

16. The turbine air intake 13, wherein the bypass is at least 25 percent of a cross-section of an airflow path through the reconfigurable heat exchanger.

17. A system, comprising:
a compressor of a gas turbine engine; and
a turbine air intake coupled to the compressor and configured to provide air to the compressor, wherein the turbine air intake comprises one or more stationary coil panels and one or more reconfigurable coil panels, wherein each reconfigurable coil panel is reconfigurable between a first position and a second position, wherein the second position opens a bypass region for the airflow

18. The system of claim 17, wherein each reconfigurable coil panel overlaps one of the one or more stationary coil panels in the second position.

19. The gas turbine engine of claim 17, comprising a ball screw mechanism coupled to the one or more reconfigurable coil panels, wherein the ball screw mechanism comprises a motor configured to rotate a shaft to translate the one or more reconfigurable coil panels.

20. The gas turbine engine of claim 17, wherein the one or more reconfigurable coil panels are removable from the turbine air intake, wherein each reconfigurable heat transfer component is installed in the turbine air intake in the first position and removed in the second position.
